(19) United States
(12) Patent Application Publication
(10) Pub. No.: US 2016/0025484 A1
(43) Pub. Date: Jan. 28, 2016

(54) OVERLAY MEASUREMENT DEVICE AND METHOD AND METHOD OF FORMING OVERLAY PATTERN

(71) Applicant: Samsung Electronics Co., Ltd., Suwon-si (KR)

(72) Inventors: Tae-Sun KIM, Hwaseong-si (KR); Jae-Kyung SEO, Yongin-si (KR); Kwang-Sub YOON, Yongin-si (KR); Bi-Zheng WANG, Suwon-si (KR); Ki-Man LEE, Yongin-si (KR); Bum-Joon YOUN, Suwon-si (KR)

(21) Appl. No.: 14/638,702

(22) Filed: Mar. 4, 2015

(30) Foreign Application Priority Data
Jul. 23, 2014 (KR) 10-2014-0093290

(51) Int. Cl. G01B 11/27

(52) U.S. Cl. CPC G01B 11/27

(57) ABSTRACT

Example embodiments relate to an overlay measurement device and method of forming an overlay pattern. The overlay measurement device includes a tray part with a substrate having a first region and a second region, a measurement part which measures an overlay of a first or second element, and a processor part which receives data measured by the measurement part and corrects the position of the first or second element, wherein the substrate comprises a first layer comprising the first overlay marks, a second layer comprising the second overlay marks, which intersects the first direction, in the second region and not comprising overlay marks which are used to measure the overlay of the second element; and the photoresist pattern which is formed on the first and second layers and overlaps the first and second overlay marks.

This application claims priority from Korean Patent Application No. 10-2014-0093290 filed on Jul. 23, 2014 in the Korean Intellectual Property Office, the disclosure of which is incorporated herein by reference in its entirety.

### BACKGROUND

1. Field of the Invention

Example embodiments relate to an overlay measurement device and/or a method of forming an overlay pattern.

2. Description of the Related Art

In the process of fabricating a semiconductor integrated circuit (IC) device, an exposure process is typically performed to form fine patterns on a semiconductor substrate. The exposure process typically includes coating photoresist on a semiconductor substrate, applying heat to the semiconductor substrate coated with the photoresist, aligning patterns formed on a mask with patterns on the surface of the semiconductor substrate, and exposing the photoresist of corresponding portions to light by partially transmitting light through the mask, removing portions through which the light transmitted or portions through which the light did not transmit using a chemical action by spraying a developing solution, forming patterns on the semiconductor substrate, and measuring the alignment state of the patterns and finding defects.

During an overlay process for measuring the alignment state of the patterns on the semiconductor substrate and for finding defects, it is determined whether a lower thin-film layer pattern formed on the semiconductor substrate and an upper thin-film layer pattern formed on the lower thin-film layer pattern are accurately aligned with each other. To measure the alignment state of the patterns on the semiconductor substrate, an overlay mark pattern may be formed on each of an upper thin-film layer and a lower thin-film layer. The positions of the overlay mark patterns may then be compared to measure the alignment state of the upper thin-film layer pattern and the lower thin-film layer pattern.

### SUMMARY

Example embodiments relate to an overlay measurement device configured to reduce the number of overlay patterns used, to reduce a scribe line, and to reduce overlay measurement time by using a merged overlay pattern.

Example embodiments relate to an overlay measurement method configured to can reduce the number of overlay patterns used, reduce a scribe line, and reduce overlay measurement time by using a merged overlay pattern.

Example embodiments relate to a method of forming an overlay pattern, the method being employed to reduce the number of overlay patterns used, reduce a scribe line, and reduce overlay measurement time by using a merged overlay pattern.

However, example embodiments are not restricted to the one set forth herein. The above and other aspects of the example embodiments will become more apparent to one of ordinary skill in the art by referencing the detailed description given below.

According to example embodiments, an overlay measurement device includes a tray part provided with a substrate having a first region and a second region, a measurement part configured to measure an overlay of a first or second element using a photoresist pattern and first or second overlay marks, and a processor part configured to receive data measured by the measurement part and to correct the position of the first or second element, wherein the substrate comprises a first layer comprising the first overlay marks used to measure the overlay of the first element formed in the first region and extend along a first direction in the second region, a second layer comprising the second overlay marks used to measure the overlay of the second element formed in the first region and extend along a second direction, which intersects the first direction, in the second region and not comprising overlay marks used to measure the overlay of the second element and extend along the first direction; and the photoresist pattern which is formed on the first and second layers and overlaps the first and second overlay marks.

According to example embodiments, an overlay measurement method includes receiving a substrate which comprises a first layer and a second layer, measuring an overlay of a first element using first overlay marks, and measuring an overlay of a second element using second overlay marks, wherein the first layer comprises the first overlay marks used to measure the overlay of the first element formed on the substrate in a first direction and does not comprise overlay marks used to measure the overlay of the first element in a second direction intersecting the first direction, and the second layer disposed on the first layer comprises the second overlay marks used to measure the overlay of the second element formed on the substrate and different from the first element, wherein the overlay of the first element is measured using the first overlay marks, and the overlay of the second element is measured using the second overlay marks.

According to example embodiments, an overlay measurement method includes receiving data about overlay marks used to measure an overlay of a first element formed on a substrate and measuring the overlay of the first element, and receiving data about overlay marks used to measure an overlay of a second element formed on the substrate and different from the first element and measuring the overlay of the second element, wherein the overlay of the first element is measured by receiving data about only first overlay marks among the first overlay marks extending along a first direction and second overlay marks extending along a second direction which intersects the first direction, and the overlay of the second element is measured by receiving data about only fourth overlay marks among third overlay marks extending along the first direction and the fourth overlay marks extending along the second direction.

According to example embodiments, a method of forming an overlay pattern includes providing a substrate in which first and second regions are defined, forming first overlay marks together with a first element of the first region to be located within a first layer of the second region and extend along a first direction, forming second overlay marks together with a second element of the first region to be located within a second layer of the second region and extend along a second direction intersecting the first direction, and forming a photoresist pattern on the first and second overlay marks to overlap the first and second overlay marks, wherein the second element is different from the first element, and the second layer is different from the first layer.

According to at least one example embodiment, an overlay measurement device includes a substrate having a first region and a second region, and an overlay pattern on the second region and including a first layer on the substrate and having first overlay marks extending along a first direction, a second layer on the first layer having second overlay marks extending along a second direction substantially orthogonal to the first direction, and a photoresist pattern on the second layer and overlapping the first and second overlay marks.

### BRIEF DESCRIPTION OF THE DRAWINGS

The above and other example embodiments will become more apparent by describing in detail example embodiments thereof with reference to the attached drawings, in which:

FIG. 1 is a block diagram of an overlay measurement device according to an example embodiment;

FIG. 2 is a block diagram of an overlay measurement device according to another example embodiment;

FIG. 3 is a layout view of a substrate according to an example embodiment;

FIG. 4 is a plan view of a first layer of an overlay pattern according to a first example embodiment;

FIG. 5 is a plan view of a second layer of the overlay pattern according to the first example embodiment;

FIG. 6 is a plan view of a photoresist pattern of the overlay pattern according to the first example embodiment;

FIG. 7 is an enlarged view of a portion A′ of FIG. 6;

FIG. 8 is a plan view of a photoresist pattern of an overlay pattern according to a second example embodiment;

FIG. 9 is a cross-sectional view taken along the line A-A of FIG. 6;

FIG. 10 is a cross-sectional view of an overlay pattern according to a third example embodiment;

FIG. 11 is a cross-sectional view of an overlay pattern according to a fourth example embodiment;

FIG. 12 is a cross-sectional view of an overlay pattern according to a fifth example embodiment;

FIG. 13 is a cross-sectional view of a semiconductor device according to an example embodiment;

FIG. 14 is a cross-sectional view of a semiconductor device according to another example embodiment;

FIGS. 15 through 20 are views illustrating a method of forming an overlay pattern according to an example embodiment;

FIGS. 21 through 26 are diagrams illustrating a method of forming an overlay pattern according to another example embodiment;

FIG. 27 is a block diagram of a semiconductor device using overlay measurement devices or methods according to example embodiments;

FIG. 28 is a block diagram of a wireless communication device including a semiconductor device that uses overlay measurement devices or methods according to example embodiments;

FIG. 29 is a block diagram of an electronic system including a semiconductor device that uses overlay measurement devices or methods according to example embodiments; and

FIGS. 30 through 32 illustrate examples of a semiconductor system to which a semiconductor device using overlay measurement devices or methods according to example embodiments can be applied.

### DETAILED DESCRIPTION

Advantages and features of the example embodiments and methods of accomplishing the same may be understood more readily by reference to the following detailed description of example embodiments and the accompanying drawings. The example embodiments may, however, be embodied in many different forms and should not be construed as being limited to the embodiments set forth herein. Rather, these example embodiments are provided so that this disclosure will be thorough and complete and will fully convey the concept of the inventive concept to those skilled in the art, and the example embodiments will only be defined by the appended claims. Like reference numerals refer to like elements throughout the specification.

The terminology used herein is for the purpose of describing particular embodiments only and is not intended to be limiting of the inventive concept. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element or layer is referred to as being “on”, “connected to” or “coupled to” another element or layer, it can be directly on, connected or coupled to the other element or layer or intervening elements or layers may be present. In contrast, when an element is referred to as being “directly on”, “directly connected to” or “directly coupled to” another element or layer, there are no intervening elements or layers present. As used herein, the term “and/or” includes any and all combinations of one or more of the associated listed items. Further, it will be understood that when a layer is referred to as being “under” another layer, it can be directly under or one or more intervening layers may also be present. In addition, it will also be understood that when a layer is referred to as being “between” two layers, it can be the only layer between the two layers, or one or more intervening layers may also be present.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the example embodiments.

Spatially relative terms, such as “beneath”, “below”, “lower”, “above”, “upper”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

In the drawing figures, the dimensions of layers and regions may be exaggerated for clarity of illustration. Like reference numerals refer to like elements throughout. The same reference numbers indicate the same components throughout the specification.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

Example embodiments are described herein with reference to cross-section illustrations that are schematic illustrations of idealized embodiments (and intermediate structures). As such, variations from the shapes of the illustrations as a result, for example, of manufacturing techniques and/or tolerances, are to be expected. Thus, these embodiments should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the example embodiments.

Unless otherwise defined, all terms (including technical and scientific terms) used herein have the same meaning as commonly understood by one of ordinary skill in the art to which the example embodiments belong. It will be further understood that terms, such as those defined in commonly used dictionaries, should be interpreted as having a meaning that is consistent with their meaning in the context of the relevant art and this specification and will not be interpreted in an idealized or overly formal sense unless expressly so defined herein.

Although corresponding plan views and/or perspective views of some cross-sectional view(s) may not be shown, the cross-sectional view(s) of device structures illustrated herein provide support for a plurality of device structures that extend along two different directions as would be illustrated in a plan view, and/or in three different directions as would be illustrated in a perspective view. The two different directions may or may not be orthogonal to each other. The three different directions may include a third direction that may be orthogonal to the two different directions. The plurality of device structures may be integrated in a same electronic device. For example, when a device structure (e.g., a memory cell structure or a transistor structure) is illustrated in a cross-sectional view, an electronic device may include a plurality of the device structures (e.g., memory cell structures or transistor structures), as would be illustrated by a plan view of the electronic device. The plurality of device structures may be arranged in an array and/or in a two-dimensional pattern.

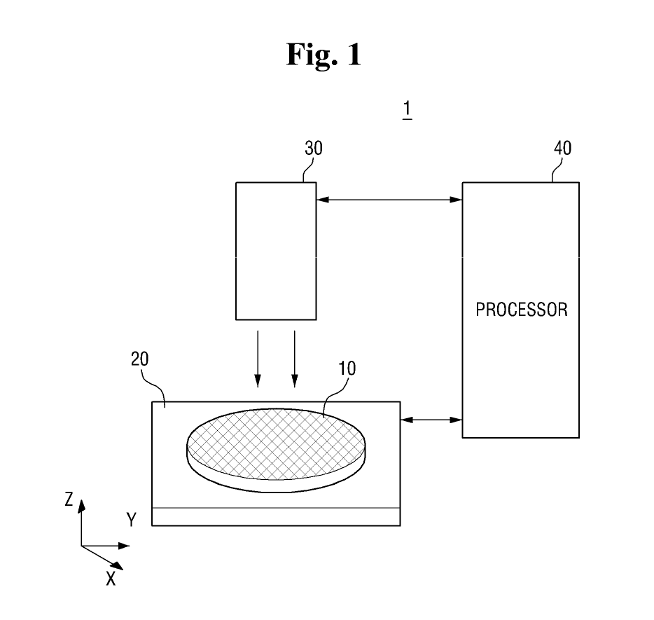

Hereinafter, overlay measurement devices and methods and methods of forming an overlay pattern according to example embodiments of the example embodiments will be described with reference to FIGS. 1 through 26.

FIG. 1 is a block diagram of an overlay measurement device 1 according to an example embodiment.

Referring to FIG. 1, the overlay measurement device 1 according to the example embodiment includes a tray part 20 provided with a wafer 10, a measurement part 30, and a processor part 40.

The tray part 20 may carry the wafer 10. That is, the tray part 20 may receive or move the wafer 10. The tray part 20 may fix the wafer 10 thereto such that the measurement part 30 can measure an overlay of a semiconductor chip included in the wafer 10. In addition, the tray part 20 can perform a planar motion in X and Y directions. The tray part 20 may be connected to the processor part 40 and change the position of the fixed wafer fixed onto the tray part 20 in response to a signal received from the processor part 40. However, the example embodiments are not limited thereto.

A plurality of semiconductor chips may be formed on the wafer 10. The wafer 10 may be substantially the same as a substrate 10. Thus, the wafer 10 will hereinafter be described as the substrate 10.

The substrate 10 may be or include a semiconductor substrate. The substrate 10 may be made of or include silicon (Si), strained silicon, a silicon alloy, silicon carbide (SiC), silicon germanium (SiGe), silicon germanium carbide (SiGeC), germanium (Ge), a germanium alloy, gallium arsenide (GaAs), indium arsenide (InAs), a III-V semiconductor, a II-VI semiconductor, or any combination or stack of the above materials. The substrate 10 may also be or include an organic plastic substrate instead of the semiconductor substrate. A case where the substrate 10 is made of or include silicon will hereinafter be described as an example, but the example embodiments are not limited to this case.

The substrate 10 may be of a P type or an N type. In some example embodiments, the substrate 10 may be an insulating substrate. Specifically, the substrate 10 may be a silicon-on-insulator (SOI) substrate. When the SOI substrate is used, it is possible to reduce the delay time in the operation process of a semiconductor device. However, the example embodiments are not limited thereto.

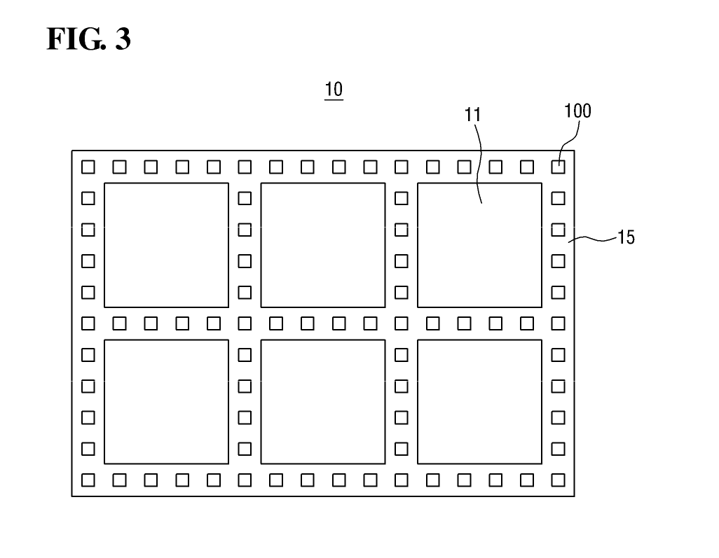

A first region (indicated by reference numeral 11 in FIG. 3) and a second region (indicated by reference numeral 15 in FIG. 3) may be formed in the substrate 10. The first region 11 may be where semiconductor chips are formed, and a plurality of transistors may be formed on the first region 11. The second region 15 may include a scribe lane. Generally, after all processes included in a semiconductor fabrication process are completed, a wafer test is conducted to detect and mark defective semiconductor chips that are not working. Then, the semiconductor chips are separated from each other using a diamond saw. Here, a region that divides the semiconductor chips is referred to as a scribe lane. This region may be formed between each semiconductor chip and another semiconductor chip. This will be described in more detail below.

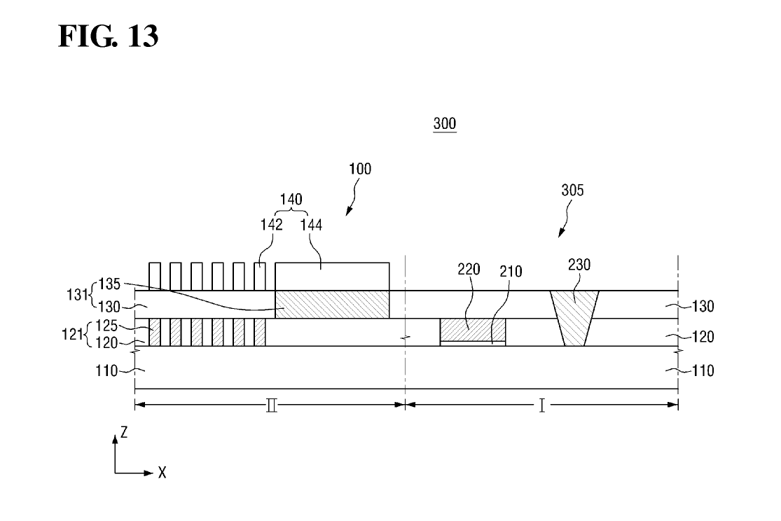

The measurement part 30 may measure an overlay of an element formed on the substrate 10. The measurement part 30 may measure an overlay of a first element (e.g., a gate electrode 220 of FIG. 13) or a second element (e.g., a contact plug 230 of see FIG. 13) of the first region (indicated by reference character I in FIG. 13) using a photoresist pattern 140 (see FIG. 13) of the second region (indicated by reference character II in FIG. 13) and first overlay marks 125 (see FIG. 13) or second overlay marks 135 (see FIG. 13). Specifically, the measurement part 30 may use, but is not limited to, an overlay measurement method in which the degree of overlap between a pattern formed in a previous step and a pattern formed in a current step is measured using diffracted light.

Fabricating a semiconductor chip typically requires a process of forming a plurality of elements. Patterns that define these elements are formed by a photolithography process. A typical photolithography process is generally performed in, for example, the following order.

First, a photoresist layer is spin-coated on a wafer. Then, coordinate values of an alignment key formed in a previous step by a photolithography process involving an etching process are read using exposure equipment based on a change in the intensity of diffracted light caused by a monochromatic laser or a contrast between light and shade caused by broadband white light. Next, a correction value using the coordinate values is calculated, and a portion to be exposed is accurately aligned at a specific position based on the correction value.

After the alignment process, the photoresist layer is selectively exposed to light such as ultraviolet (UV) rays, electron beams, or X rays. Then, the photoresist layer is patterned by a development process. After the patterning of the photoresist layer, an overlay measurement device determines whether a pattern formed in a current step using overlay marks matches a pattern formed in a previous step.

According to at least one example embodiment, the measurement part 30 may use, as a light source, broadband light to detect an overlay mark based on the contrast between light and shade or use monochromatic light to recognize the position of an overlay mark based on the difference between intensities of light diffracted by the overlay mark. When utilizing the broadband light, fabricating a semiconductor chip is less affected by the surface state of a lower structure. When utilizing the monochromatic light using a diffraction phenomenon, fabricating a semiconductor chip can increase alignment accuracy. Overlay measurement devices and methods will hereinafter be described assuming that an overlay is measured using the diffraction phenomenon.

The processor part 40 may receive data measured by the measurement part 30 and correct a position at which the first element or the second element is to be formed based on the received data. Specifically, the processor part 40 may read the result of overlay measurement and perform a subsequent process such as an etching process if the result (the measured value) is “spec-in,” or within the specification requirements. If the result (the measured value) is “spec-out,” or outside of the specification requirements, the processor part 40 may calculate a correction value for misalignment and perform additional exposure and development processes based on the correction value. However, the example embodiments are not limited thereto.

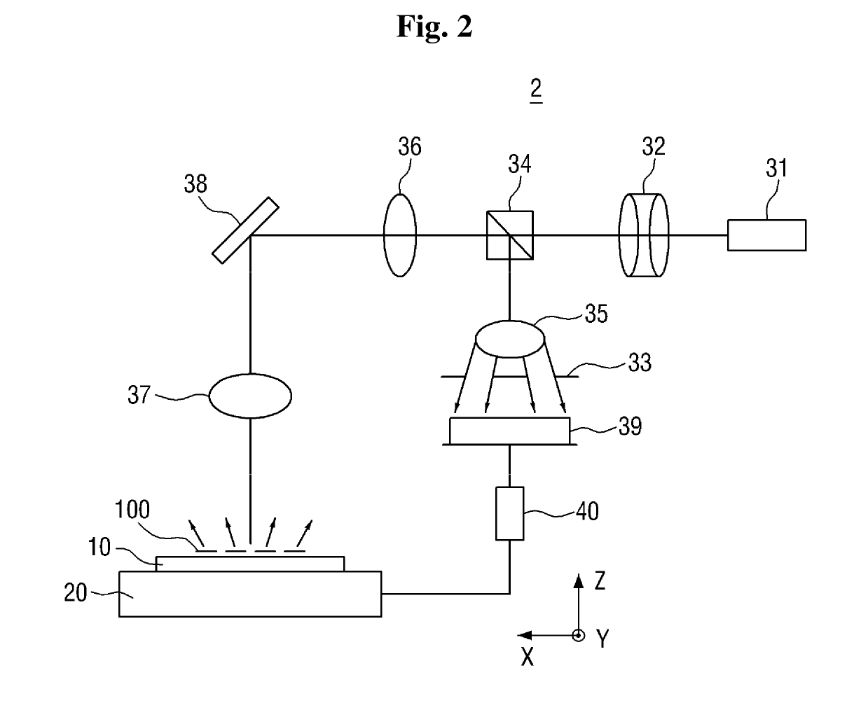

FIG. 2 is a block diagram of an overlay measurement device 2 according to another example embodiment.

Referring to FIG. 2, the overlay measurement device 2 according to the example embodiment includes a light source 31 which emits monochromatic light. Overlay marks and a wafer 10 having the overlay marks are placed on the path of the monochromatic light. The light source 31 may be, but is not limited to, a highly monochromatic laser light source.

In addition, the overlay measurement device 2 of the example embodiments may include a collimator 32, a beam splitter 34 which selectively splits light, lenses 35 through 37 which focus light, a reflector 38 which changes the path of light, a filter 33 which partially blocks light, and a photodetector 39 which receives light and converts the light signal into an electrical signal.

According to at least one example embodiment, laser light emitted from the light source 31 is irradiated onto the wafer 10 via the lens 37. The wafer 10 may be placed on a tray part 20 capable of performing a planar motion in X and Y directions.

Light diffracted by each overlay mark on the wafer 10 is reflected by the beam splitter 34 in a direction different from the initial path of the light. The filter 33 may be placed on the path of the reflected light to partially pass the diffracted light therethrough by partially blocking the diffracted light. The diffracted light that passes through the filter 33 is received by the photodetector 39. The photodetector 39 may be connected to a processor part 40 which controls the planar motion of the wafer 10 in the X and Y directions. However, the example embodiments are not limited thereto, and some elements can be omitted or added.

FIG. 3 is a layout view of a substrate 10 according to an example embodiment.

Referring to FIG. 3, the substrate 10 includes a first region 11 and a second region 15. A plurality of transistors may be formed in the first region 11. That is, the first region 11 is where semiconductor chips are formed. The second region 15 may include a scribe lane. An alignment key (not illustrated) and overlay patterns 100 may be placed in the scribe lane.

The scribe lane may surround a region where semiconductor chips are formed. The scribe lane may be placed between the semiconductor chips in a cross shape, and the semiconductor chips may be arranged in a lattice shape. That is, sections of the first region 11 may be arranged in a lattice shape, and the second region 15 may include a quadrilateral region which surrounds outermost edges of the first region 11 and a cross-shaped region which is disposed between the sections of the first region 11.

In a semiconductor fabrication process, a plurality of masks or reticles may be used to form a desired pattern on the substrate 10. Here, the alignment key and overlay marks are essentially used.

Alignment refers to placing each mask or reticle in a position corresponding to the position of a desired, or alternatively predetermined reference (e.g., the alignment key) when a plurality of masks or reticles are sequentially applied to a wafer. This concept of alignment is reflected not only when a wafer is fabricated but also when a reticle is formed. On the other hand, an overlay process refers to forming a desired pattern through exposure and then identifying whether the position of a pattern formed is correct. If there is a difference between the desired pattern and the pattern formed, a measured overlay value is fed back so as to adjust the position of a pattern to be formed afterwards.

Overlay observation equipment (e.g., the overlay measurement device 1 or 2 of FIG. 1 or FIG. 2) senses light reflected by the overlay patterns 100. Therefore, the overlay patterns 100 may be installed in the scribe lane to not overlap each other in view of the interference of light. In addition, since the overlay patterns 110 are installed at regular intervals, an increase in the number of overlay patterns 100 leads to an increase in the used area of the scribe lane. Therefore, if the number of overlay patterns 100 used is reduced, the used area of the scribe lane can be reduced, and overlay measurement time can be reduced. Consequently, reducing overlay patterns offers benefits in terms of cost and time.

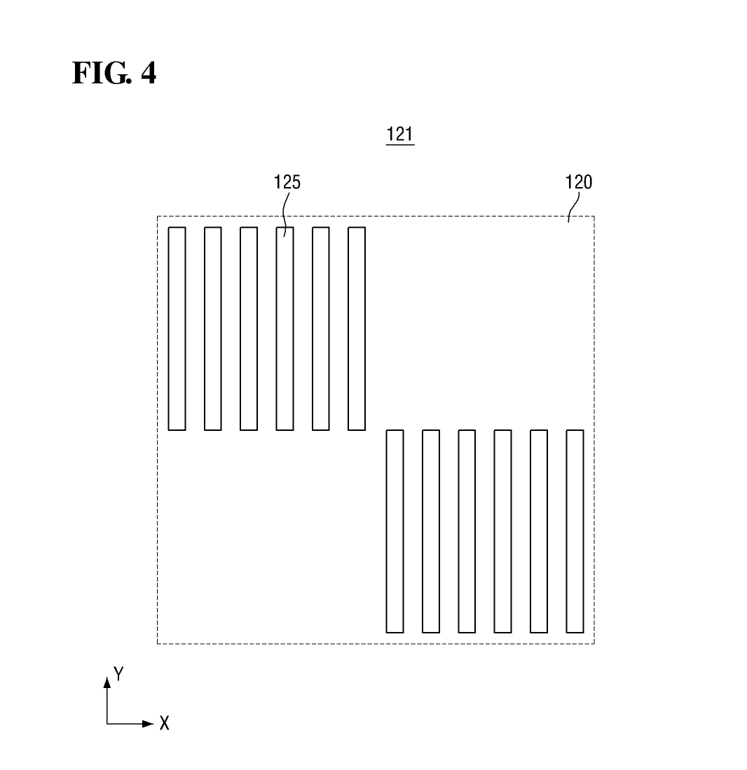

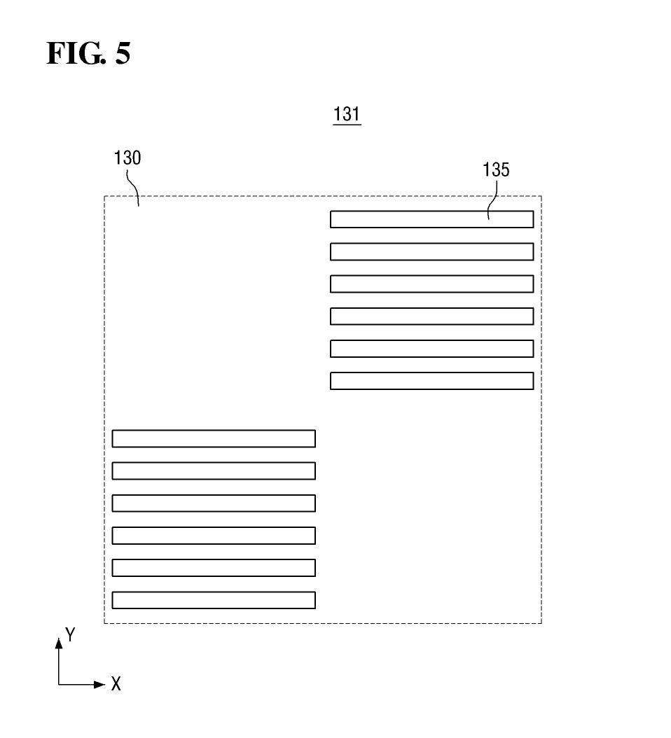

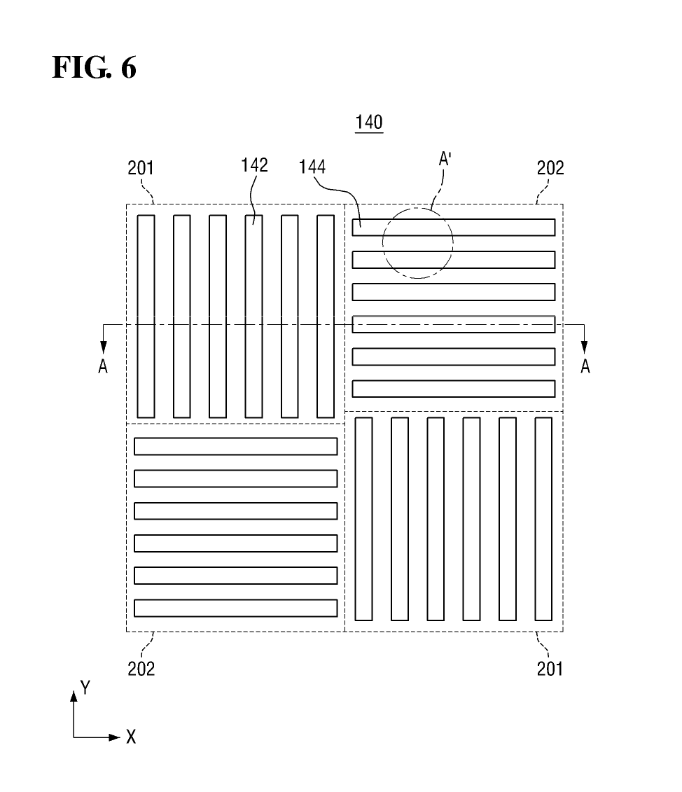

FIG. 4 is a plan view of a first layer 121 of an overlay pattern 100 according to a first example embodiment. FIG. 5 is a plan view of a second layer 131 of the overlay pattern 100 according to the first example embodiment. FIG. 6 is a plan view of a photoresist pattern 140 of the overlay pattern 100 according to the first example embodiment.

Referring to FIG. 4, the first layer 121 of the overlay pattern 100 according to the first example embodiment includes first overlay marks 125. The first overlay marks 125 may extend along a first direction (a Y-axis direction). The first overlay marks 125 may be grating-based marks. Since the first overlay marks 125 extend along the first direction (the Y-axis direction), an overlay of a first element in an X-axis direction can be measured. The first element may extend in the same direction (e.g., the first direction) as the first overlay marks 125, but the example embodiments are not limited thereto.

The first overlay marks 125 may measure an overlay using a diffraction phenomenon and may be arranged at regular intervals. However, the example embodiments are not limited thereto, and the first overlay marks 125 may also be arranged at irregular intervals.

A space between the first overlay marks 125 may be filled with a first interlayer insulating film 120. The first interlayer insulating film 120 may be formed on a substrate 110. The first interlayer insulating film 120 may electrically insulate semiconductor devices disposed under the first interlayer insulating film 120 from semiconductor devices disposed on the first interlayer insulating film 120. The first interlayer insulating film 120 may be made of or include silicon oxide such as borosilicate glass (BSG), phosphosilicate glass (PSG), borophosphosilicate glass (BPSG), undoped silicate glass (USG), tetraethylorthosilicate glass (TEOS), or high density plasma-CVD (HDP-CVD), but the example embodiments are not limited thereto.

Referring to FIG. 5, the second layer 131 of the overlay pattern 100 according to the first example embodiment includes second overlay marks 135. The second layer 131 may be disposed at a different level from the first layer 121. For example, the second layer 131 may be located on or under the first layer 121.

The second overlay marks 135 may extend along a second direction (the X-axis direction) intersecting the first direction. Like the first overlay marks 125, the second overlay marks 135 may be grating-based marks. The second overlay marks 135 may be formed along the second direction intersecting the first direction. For example, the second direction may be the X-axis direction orthogonal to the Y-axis direction which is the first direction. Accordingly, an overlay of a second element in the Y-axis direction can be measured. However, the example embodiments are not limited thereto.

The second overlay marks 135 may measure an overlay using a diffraction phenomenon and may be arranged at regular intervals. However, the example embodiments are not limited thereto, and the second overlay marks 135 may also be arranged at irregular intervals. In addition, the second overlay marks 135 may be placed to not overlap the first overlay marks 125.

A space between the second overlay marks 135 may be filled with a second interlayer insulating film 130. The second interlayer insulating film 130 may be formed on the substrate 110. The second interlayer insulating film 130 may electrically insulate semiconductor devices disposed under the second interlayer insulating film 130 from semiconductor devices disposed on the second interlayer insulating film 130. The second interlayer insulating film 130 may be made of or include silicon oxide such as BSG, PSG, BPSG, USG, TEOS, or HDP-CVD, but the example embodiments are not limited thereto.

Referring to FIG. 6, the overlay pattern 100 according to the first example embodiment includes the photoresist pattern 140. The photoresist pattern 140 may be located on the first overlay marks 125 and the second overlay marks 135. The photoresist pattern 140 may include two or more adjacent rectangular regions 201 and 202, and each of the rectangular regions 201 and 202 of the photoresist pattern 140 may include first patterns 142 or second patterns 144.

The first patterns 142 may be formed such that the photoresist extends along the first direction, and may have substantially the same shape as the first overlay marks 125. In addition, the first patterns 142 may be placed to overlap the first overlay marks 125.

Likewise, the second patterns 144 may be formed such that the photoresist extends along the second direction intersecting the first direction, and may have substantially the same shape as the second overlay marks 135. In addition, the second patterns 144 may be placed to overlap the second overlay marks 135.

That is, the photoresist pattern 140 may be a merged version of the first overlay marks 125 and the second overlay marks 135 in the same plane. The first patterns 142 and the second patterns 144 may be alternately and repeatedly arranged to form grating-based patterns.

The photoresist pattern 140 may be formed by an optical device (not illustrated) including a light source (not illustrated) which provides an exposure beam, a digital micro-mirror device (DMD, not illustrated) which modulates the exposure beam provided by the light source (not illustrated) according to an exposure pattern, and an exposure optical system (not illustrated) which projects the modulated exposure beam received from the DMD (not illustrated) onto the substrate 110 in the form of a beam spot array. However, the example embodiments are not limited thereto.

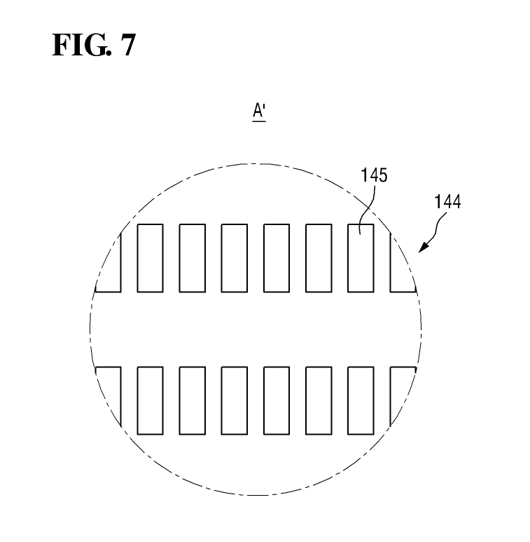

FIG. 7 is an enlarged view of a portion A′ of FIG. 6.

Referring to FIG. 7, the first overlay marks 125, the second overlay marks 135, or the photoresist pattern 140 of the overlay pattern 100 of the example embodiments may include groups of sub-patterns 145. In FIG. 7, a group of sub-patterns 145 included in each second pattern 144 of the photoresist pattern 140 are illustrated as an example, but the example embodiments are not limited to this example.

In the example process of forming the overlay pattern 100, the overlay pattern 100 may sometimes not be formed accurately or may be partially deteriorated. In this case, if an overlay is calculated using only one numerical value, the alignment state of a thin layer may be calculated incorrectly. However, if the first overlay marks 125, the second overlay marks 135, or the photoresist pattern 140 are composed of sub-patterns, overlay data can be calculated by using measured values of the sub-patterns together. Thus, a more accurate value can be calculated.

Furthermore, the arrangement of groups of sub-patterns may add particular characteristics to a pattern. Therefore, a plurality of overlap patterns 100 may be formed adjacent to each other. Accordingly, the space utilization of a scribe region on a wafer having the overlap patterns 100, and, the integration density of semiconductor integrated circuit (IC) devices, can be increased. However, the example embodiments are not limited thereto.

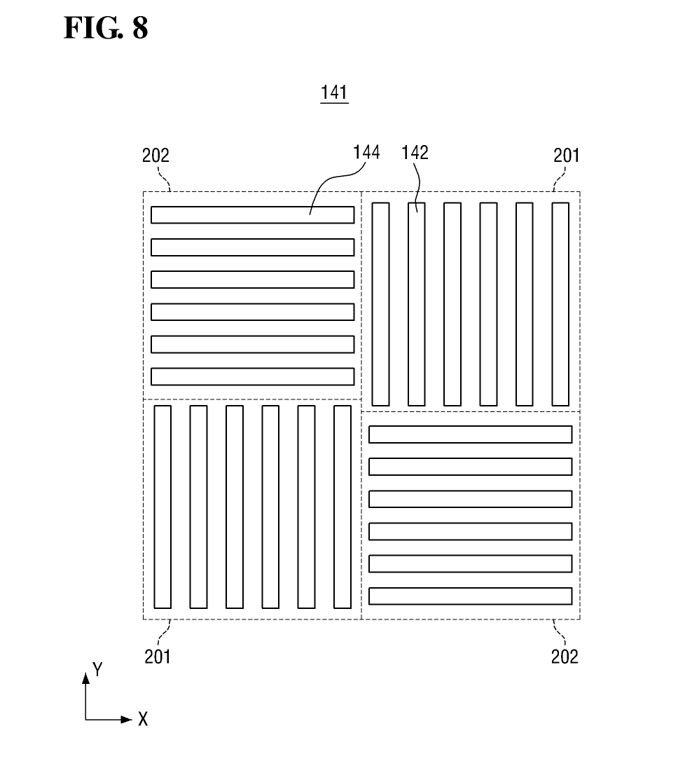

FIG. 8 is a plan view of a photoresist pattern 141 of an overlay pattern 101 according to a second example embodiment.

Referring to FIG. 8, the photoresist pattern 141 of the overlay pattern 101 according to the second example embodiment may be substantially the same as the photoresist pattern 140 described above with reference to FIG. 6. However, first patterns 142 extending along a first direction and second patterns 144 extending along a second direction in the photoresist pattern 141 of FIG. 8 may be located in reverse positions from the first patterns 142 and the second patterns 144 included in the photoresist pattern 140 of FIG. 6.

Although not specifically illustrated in the drawing, since the first patterns 142 are formed in the same shape as the first overlay marks 125, the positions of the first overlay marks 125 located under the first patterns 142 may also be changed to the positions of the first patterns 142. Likewise, the positions of second overlay marks 135 located under the second patterns 144 may also be changed to the positions of the second patterns 144.

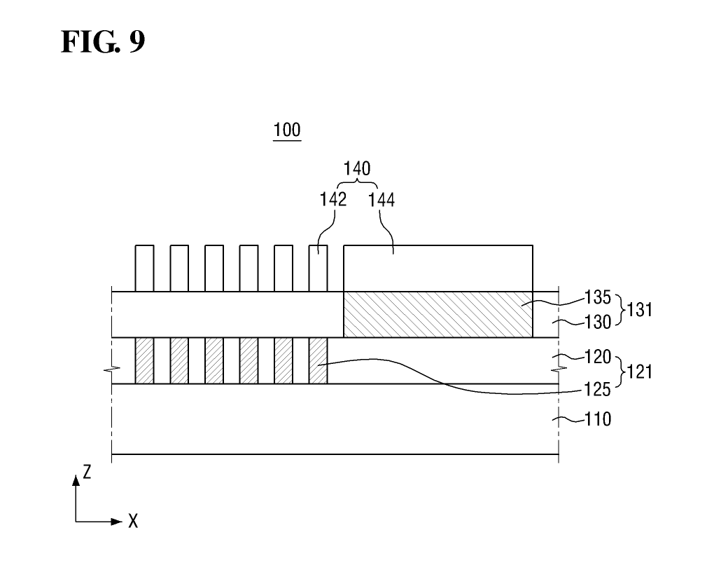

FIG. 9 is a cross-sectional view taken along the line A-A of FIG. 6.

Referring to FIG. 9, the overlay pattern 100 according to the first example embodiment includes the substrate 110, the first layer 121, the second layer 131, and the photoresist pattern 140.

The first layer 121 may be formed on the substrate 110. The first layer 121 may include the first interlayer insulating film 120 and the first overlay marks 125 extending along the first direction within the first layer 121. The first interlayer insulating film 120 may contact side surfaces of the first overlap marks 125 and the substrate 110.

The second layer 131 may be formed on the first layer 121. The second layer 131 may include the second interlayer insulating film 130 and the second overlay marks 135 extending along the second direction, which intersects the first direction, within the second layer 131 different from the first layer 121. Although not specifically illustrated in the drawing, the second interlayer insulating film 130 may contact side surfaces of the second overlay marks 135. In addition, the second interlayer insulating film 130 may contact the first interlayer insulating film 120.

The photoresist pattern 140 may be formed on the second layer 131. The photoresist pattern 140 may be formed to overlap the first overlay marks 125 and the second overlay marks 135. This is intended to measure the overlay of the first element using the diffraction phenomenon between the photoresist pattern 140 and the first overlay marks 125 and measure the overlay of the second element using the diffraction phenomenon between the photoresist pattern 140 and the second overlay marks 135. Specifically, the first overlay marks 125 extending along the first direction and the photoresist pattern 140 may measure an overlay value of the first element, which extends along the first direction, in the second direction intersecting the first direction. Likewise, the second overlay marks 135 extending along the second direction and the photoresist pattern 140 may measure an overlay value of the second element, which extends along the second direction, in the first direction intersecting the second direction. The first element and the second element may be measured sequentially or simultaneously.

That is, the example embodiments can measure an effective overlay value of each of the first element and the second element using one overlay pattern 100. Accordingly, the number of overlay patterns 100 used can be reduced by half compared with when an overlay pattern 100 is needed for each element. This reduction in the number of overlay patterns 100 used can reduce the area of the scribe lane in which the overlay patterns 100 are to be placed.

In addition, the overlay pattern 100 of the example embodiments can measure the overlay values of the first and second elements simultaneously. Therefore, the overlay measurement time can be reduced by half compared with when an overlay of each element is measured separately.

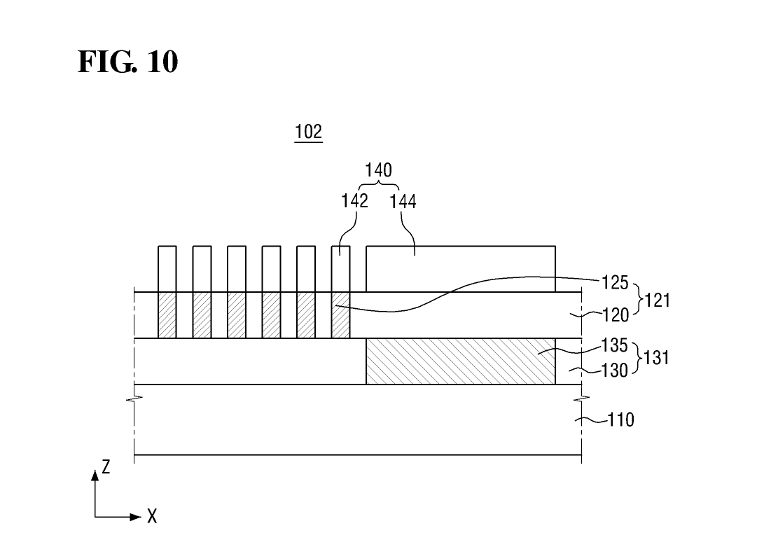

FIG. 10 is a cross-sectional view of an overlay pattern 102 according to a third example embodiment. For simplicity, a redundant description of elements substantially identical to those of the above-described example embodiments will be omitted, and the following example embodiment will be described, focusing mainly on differences with the above-described example embodiments.

Referring to FIG. 10, the overlay pattern 102 according to the third example embodiment includes a substrate 110, a first layer 121, a second layer 131, and a photoresist pattern 140.

Specifically, the second layer 131 may be formed on the substrate 110. The second layer 131 may include a second interlayer insulating film 130 and second overlay marks 135 extending along a second direction within the second layer 131. Although not specifically illustrated in the drawing, the second interlayer insulating film 130 may contact side surfaces of the second overlay marks 135 and the substrate 110.

The first layer 121 may be formed on the second layer 131. The first layer 121 may include a first interlayer insulating film 120 and first overlay marks 125 extending along a first direction, which intersects the second direction, within the first layer 121 different from the second layer 131. The first interlayer insulating film 120 may contact side surfaces of the first overlay marks 125. In addition, the second interlayer insulating film 130 may contact the first interlayer insulating film 120.

A photoresist pattern 140 may be formed on the first layer 121. The photoresist pattern 140 may be formed to overlap the first overlay marks 125 and the second overlay marks 135.

The overlay pattern 102 of FIG. 10 may operate to bring about substantially the same effect as the overlay pattern 100 of FIG. 9.

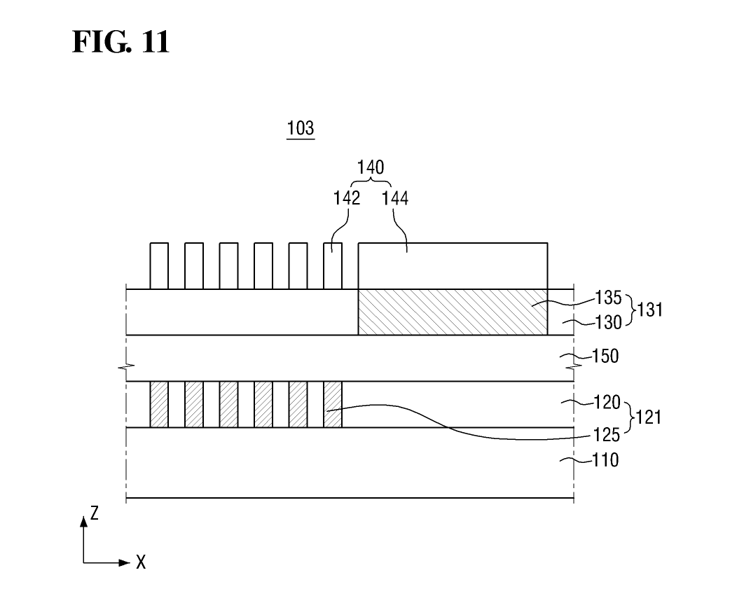

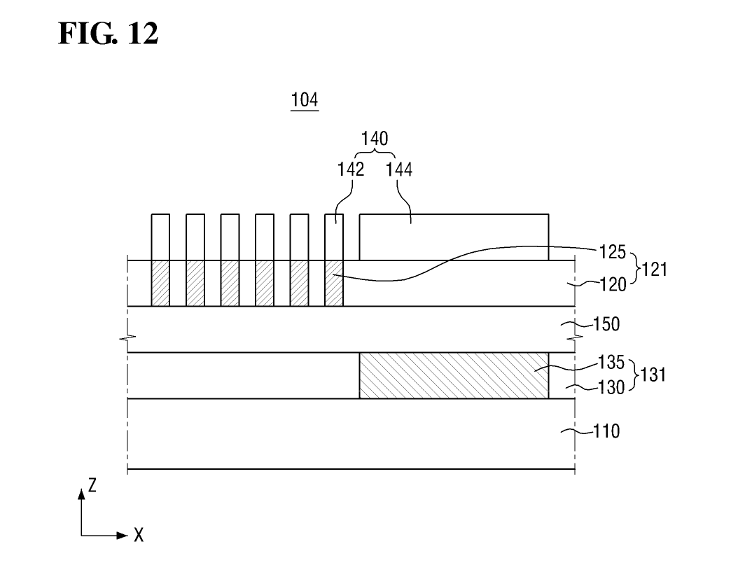

FIG. 11 is a cross-sectional view of an overlay pattern 103 according to a fourth example embodiment. FIG. 12 is a cross-sectional view of an overlay pattern 104 according to a fifth example embodiment t. For simplicity, a redundant description of elements substantially identical to those of the above-described example embodiments will be omitted, and the following example embodiments will be described, focusing mainly on differences with the above-described example embodiments.

Referring to FIG. 11, the overlay pattern 103 according to the fourth example embodiment includes a substrate 110, a first layer 121, a second layer 131, a third layer 150, and a photoresist pattern 140.

Specifically, the first layer 121 may be formed on the substrate 110. The first layer 121 may include a first interlayer insulating film 120 and first overlay marks 125 extending along a first direction within the first layer 121. The first interlayer insulating film 120 may contact side surfaces of the first overlay marks 125 and the substrate 110.

The third layer 150 may be formed on the first layer 121. The third layer 150 may consist of an interlayer insulating film. That is, the third layer 150 may electrically insulate the first layer 121 located under the third layer 150 from the second layer 131 located on the third layer 150. The third layer 150 may be made of or include silicon oxide such as BSG, PSG, BPSG, USG, TEOS, or HDP-CVD, but the example embodiments are not limited thereto.

The second layer 131 may be formed on the third layer 150. The second layer 131 may include a second interlayer insulating film 130 and second overlay marks 135, which extend in a second direction intersecting the first direction, within the second layer 131 different from the first layer 121. Although not specifically illustrated in the drawing, the second interlayer insulating film 130 may cover side surfaces of the second overlay marks 135. In addition, the second interlayer insulating film 130 may contact the third layer 150.

The photoresist pattern 140 may be formed on the second layer 131. The photoresist pattern 140 may be formed to overlap the first overlay marks 125 and the second overlay marks 135. Accordingly, an overlay of a third element can be measured using the diffraction phenomenon between the photoresist pattern 140 and the first overlay marks 125, and an overlay of a fourth element can be measured using the diffraction phenomenon between the photoresist pattern 140 and the second overlay marks 135.

The overlay pattern 103 according to the fourth example embodiment is configured to measure the overlays of the third element and the fourth element located at a different level from first and second elements. To this end, the third layer 150 (e.g., the interlayer insulating film) may be disposed between the first layer 121 and the second layer 131 and may include a plurality of layers, but the example embodiments are not limited thereto.

Referring to FIG. 12, the overlay pattern 104 according to the fifth example embodiment brings about substantially the same effect as the overlay pattern 103 according to the fourth example embodiment described above with reference to FIG. 11. However, a first layer 121 and a second layer 131 included in the overlay pattern 104 of FIG. 12 may be located in reverse positions from the first layer 121 and the second layer 131 included in the overlay pattern 103 of FIG. 11.

The overlay pattern 104 according to the fifth example embodiment may be used to measure overlays of fifth and sixth elements in an opposite direction to a direction in which overlays of third and fourth elements are measured.

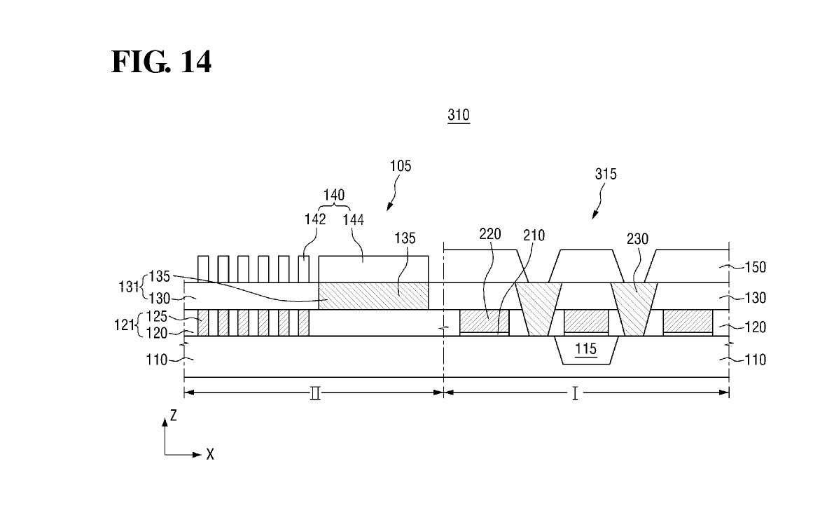

FIG. 13 is a cross-sectional view of a semiconductor device 300 according to an example embodiment. FIG. 14 is a cross-sectional view of a semiconductor device 310 according to another example embodiment. For simplicity, a redundant description of elements substantially identical to those of the above-described example embodiments will be omitted, and the following example embodiments will be described, focusing mainly on differences with the above-described example embodiments.

Referring to FIG. 13, the semiconductor device 300 according to the example embodiment includes a substrate 110, a transistor 305, and an overlay pattern 100.

A first region I and a second region II may be defined in the substrate 110. A semiconductor chip including the transistor 305 may be formed in the first region I, and the overlay pattern 100 may be disposed in the second region II.

The transistor 305 formed in the first region I may include a gate electrode 220 which is formed on the substrate 110, a gate insulating layer 210 which is disposed between the substrate 110 and the gate electrode 220, a first interlayer insulating film 120 which covers side surfaces of the gate electrode 220, a contact plug 230 which contacts an active region (not illustrated) of the substrate 110, and a second interlayer insulating film 130 which covers side surfaces of the contact plug 230 and is formed on the first interlayer insulating film 120.

The gate electrode 220 may include a conductive material. In some example embodiments, the gate electrode 220 may include a metal with high conductivity. However, the example embodiments are not limited thereto. That is, in some other example embodiments, the gate electrode 220 may also be made of or include a non-metal such as polysilicon.

The gate insulating layer 210 located between the gate electrode 220 and the substrate 110 may be made of or include a high-k material. In some example embodiments, the gate insulating layer 210 may be made of or include a material such as, but not limited to, HfO₂, Al₂O₃, ZrO₂, TaO₂, etc.

Although not specifically illustrated in the drawing, an interface layer may be additionally disposed between the gate insulating layer 210 and the substrate 110 to prevent a poor interface between the gate insulating layer 210 and the substrate 110. The interface layer may include a low-k material layer having a dielectric constant (k) of 9 or less such as a silicon oxide layer (having a dielectric constant k of approximately 4) or a silicon oxynitride layer (having a dielectric constant k of approximately 4 to 8 according to contents of oxygen and nitrogen atoms). Alternatively, the interface layer may be made of or include silicate or any combination of the above example layers.

The first interlayer insulating film 120 may be formed on the semiconductor substrate 110. The first interlayer insulating film 120 may electrically insulate elements disposed under the first interlayer insulating film 120 from elements disposed on the first interlayer insulating film 120. The first interlayer insulating film 120 may be made of or include silicon oxide such as BSG, PSG, BPSG, USG, TEOS, or HDP-CVD, but the example embodiments are not limited thereto.

The contact plug 230 may electrically contact the active region (not illustrated) of the substrate 110. In some example embodiments, the contact plug 230 may be connected to a source contact or a drain contact, but the example embodiments are not limited thereto.

The second interlayer insulating film 130 may be formed on the first interlayer insulating film 120. The second interlayer insulating film 130 may electrically insulate elements disposed under the second interlayer insulating film 130 from elements disposed on the second interlayer insulating film 130. The second interlayer insulating film 130 may contact the side surfaces of the contact plug 230 and a top surface of the first interlayer insulating film 120.

The overlay pattern 100 formed in the second region II may include the first interlayer insulating film 120, the second interlayer insulating film 130, and a photoresist pattern 140.

First overlay marks 125 may extend along a first direction within the first interlayer insulating film 120 and may include the same material as a first element. For example, the first element may be the gate electrode 220, and the first overlay marks 125 and the gate electrode 220 may include, but not limited to, SiON, TiN, W or TiAIC. The first interlayer insulating film 120 of the overlay pattern 110 may be made of or include the same material as the first interlayer insulating film 120 of the transistor 305.

Second overlay marks 135 may extend along a second direction intersecting the first direction within the second interlayer insulating film 130 and may include the same material as a second element. For example, the second element may be the contact plug 230, and the second overlay marks 135 and the contact plug 230 may include, but not limited to, TiN, W, or TiAIC. The second interlayer insulating film 130 of the overlay pattern 100 may be made of or include the same material as the second interlayer insulating film 130 of the transistor 305.

The photoresist pattern 140 may be disposed on the second interlayer insulating film 130 and may be formed to overlap the first overlay marks 125 and the second overlay marks 135. The photoresist pattern 140 may overlap the first overlay marks 125 and the second overlay marks 135.

In the example embodiment, the gate electrode 220 corresponding to the first element and the first overlay marks 125 may extend along the first direction (e.g., a Y-axis direction). That is, the gate electrode 220 and the first overlay marks 125 may extend in the same direction. Thus, an overlay of the second electrode 220 in the second direction (e.g., an X-axis direction) intersecting the first direction can be measured.

Likewise, the contact plug 230 corresponding to the second element and the second overlay marks 135 may extend along the second direction (e.g., the X-axis direction) intersecting the first direction. The contact plug 230 and the second overlay marks 135 may extend in the same direction. Thus, an overlay of the contact plug 230 in the second direction (e.g., the Y-axis direction) can be measured.

Referring to FIG. 14, the semiconductor device 310 according to the example embodiment includes a substrate 110, a transistor 315, and an overlay pattern 100.

A first region I and a second region II may be defined in the substrate 110. A semiconductor chip including the transistor 315 may be formed in the first region I, and the overlay pattern 100 may be disposed in the second region II. The overlay pattern 100 of FIG. 14 may be substantially the same as the overlay pattern 100 described above with reference to FIG. 13. The transistor 315 of FIG. 14 may include the substrate 110, a device isolation layer 115, a plurality of gate insulating layers 210, a plurality of gate electrodes 220, a first interlayer insulating film 120, a second interlayer insulating film 130, and a plurality of contact plugs 230.

The device isolation layer 115 may be formed in the substrate 110 to define an active region (not illustrated). The device isolation layer 115 may have, but not limited to, a shallow trench isolation (STI) structure which exhibits superior device isolation characteristics and is advantageous for high integration density because it occupies a small area. The device isolation layer 115 may include at least one of silicon oxide, silicon nitride, silicon oxynitride, and any combination of these materials.

The transistor 315 may include the gate electrodes 220 and the contact plugs 230. The gate electrodes 220 may include the same material as first overlay marks 125. For example, the first overlay marks 125 and the gate electrodes 220 may include SiON, TiN, W or TiAIC. In addition, the gate electrodes 220 may be formed at the same time as the first overlay marks 125. That is, the first interlayer insulating film 120 is formed on the substrate 110 and then etched to form the gate electrodes 220 and the first overlay marks 125, but the example embodiments are not limited thereto.

Likewise, the contact plugs 230 may include the same material as second overlay marks 135. For example, the second overlay marks 135 and the contact plugs 230 may include TiN, W or TiAIC. In addition, the contact plugs 230 may be formed at the same time as the second overlay marks 135. That is, after the formation of the gate electrodes 220 and the first overlay marks 125, the second interlayer insulating film 130 may be formed on the first interlayer insulating film 120 and then etched to form the second overlay marks 135 and the contact plugs 230. The first interlayer insulating film 120 and the second interlayer insulating film 130 in the first region I may be etched simultaneously. Accordingly, an etching depth in the first region I may be different from an etching depth in the second region II. A third interlayer insulating film for forming a source contact or a drain contact may be formed on the second interlayer insulating film 130 of the first region I, but the example embodiments are not limited thereto.

The semiconductor devices 300 and 310 according to the example embodiments can measure the overlay of the gate electrode 220 (e.g., the first element) and the overlay of the contact plug 230 (e.g., the second element) using one overlay pattern 100. Accordingly, the number of overlay patterns 100 used can be reduced by half compared with when an overlay pattern 100 is needed for each element. This reduction in the number of overlay patterns 100 used can reduce the area of a scribe lane in which the overlay patterns 100 are to be placed. In addition, the overlay pattern 100 of the example embodiments can measure overlay values of the first and second elements simultaneously. Therefore, overlay measurement time can be reduced by half compared with when an overlay of each element is measured separately

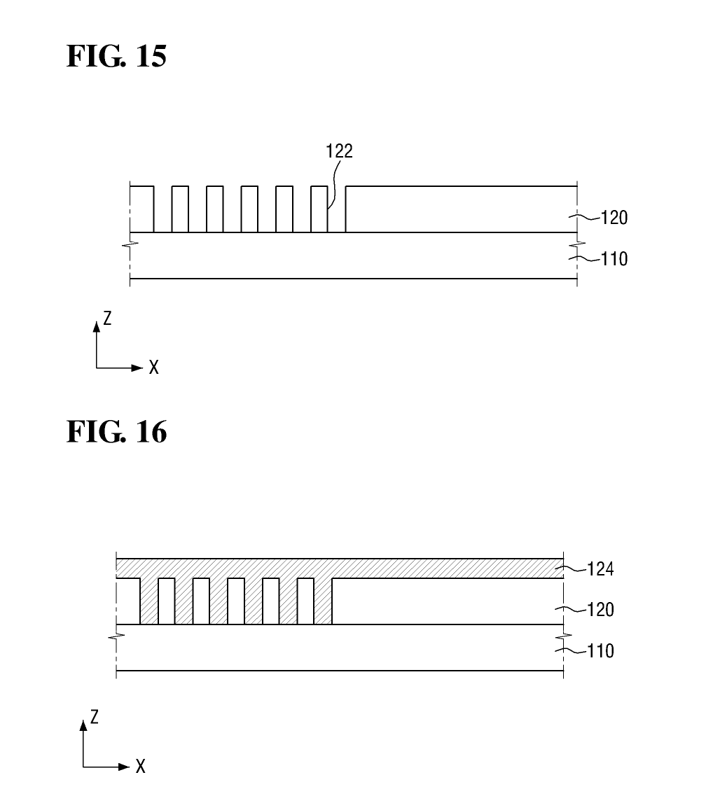

FIGS. 15 through 20 are views illustrating a method of forming an overlay pattern according to an example embodiment. For simplicity, a redundant description of elements substantially identical to those of the above-described example embodiments will be omitted, and the following example embodiments will be described, focusing mainly on differences with the above-described example embodiments.

Referring to FIG. 15, to form an overlay pattern 100 according to the example embodiment, a first interlayer insulating film 120 is formed on a substrate 110. Then, the first interlayer insulating film 120 is etched to form first trenches 122 for forming first overlay marks 125. The first trenches 122 may be formed to extend along a first direction. The first interlayer insulating film 120 may be etched using, but not limited to, dry etching, wet etching, plasma etching, etc.

Referring to FIG. 16, a first material layer 124 is formed on the first interlayer insulating film 120. The first material layer 124 may include a high-k (highly dielectric) material or a polysilicon material. For example, the first material layer 124 may include, but not limited to, SiON, TiN, W, or TiAIC.

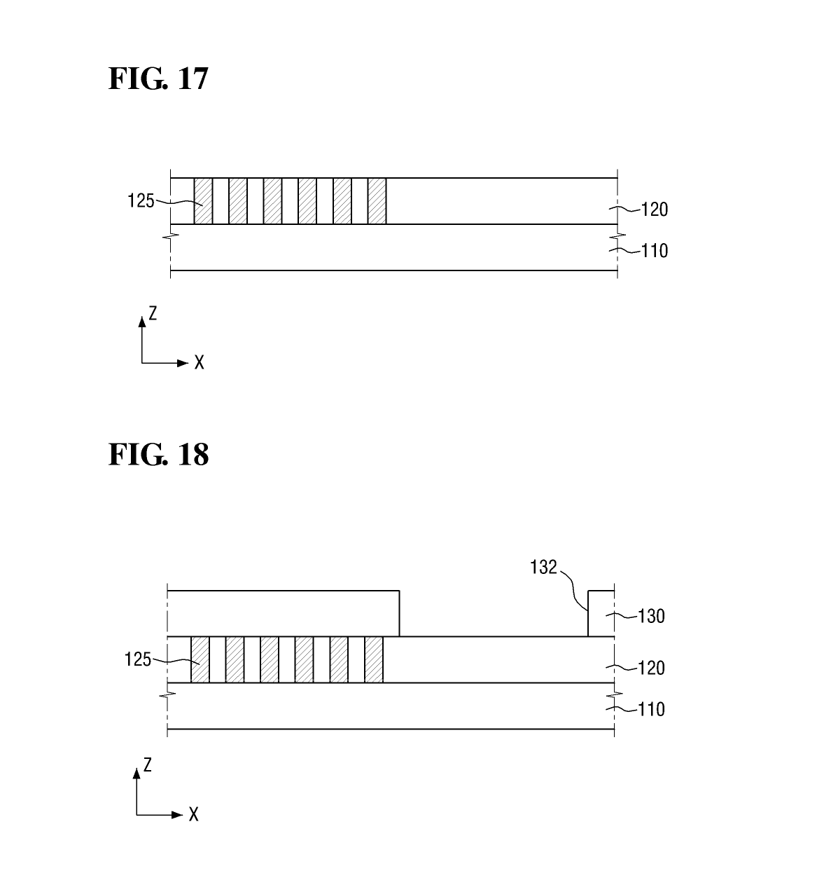

Referring to FIG. 17, the first material layer 124 is removed until a top surface of the first interlayer insulating film 120 is exposed. As a result, the first overlay marks 125 are formed. The first material layer 124 may be removed by, but not limited to, chemical mechanical polish (CMP).

Referring to FIG. 18, a second interlayer insulating film 130 is formed on the first interlayer insulating film 120. The second interlayer insulating film 130 may be made of or include substantially the same material as the first interlayer insulating film 120. The second interlayer insulating film 130 may be etched to form second trenches 132 for forming second overlay marks 135 in the second interlayer insulating film 130. The second trenches 132 may be formed to extend along a second direction intersecting the first direction of the first trenches 122. The first direction may be, but is not limited to, at a right angle to the second direction. The second interlayer insulating film 130 may be etched using, but not limited to, dry etching, wet etching, plasma etching, etc.

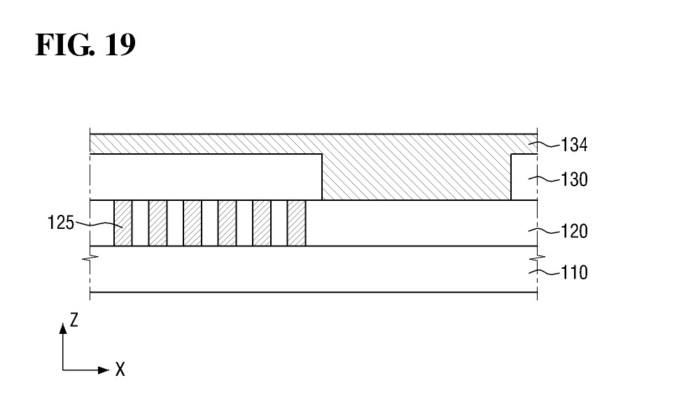

Referring to FIG. 19, a second material layer 134 is formed on the second interlayer insulating film 130. The second material layer 134 may include a high-k material or a polysilicon material. For example, the second material layer 134 may include, but not limited to, TiN, W, or TiAIC.

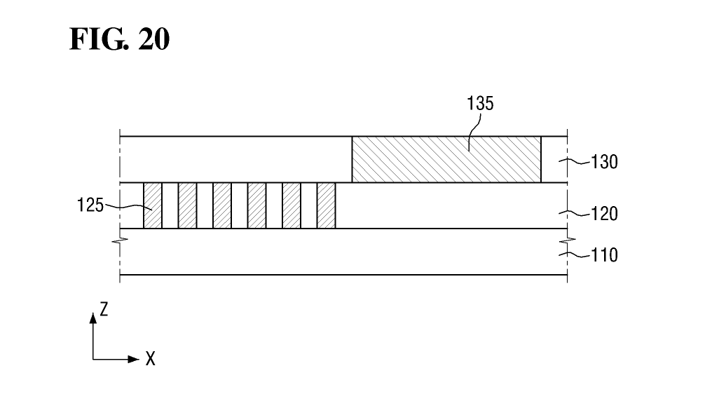

Referring to FIG. 20, the second material layer 134 is removed until a top surface of the second interlayer insulating film 130 is exposed. As a result, the second overlay marks 135 are formed. The second material layer 134 may be removed by, but not limited to, CMP.

Referring back to FIG. 9, a photoresist pattern 140 is formed on the second interlayer insulating film 130 or the second overlay mark 135. The photoresist pattern 140 may be formed to overlap the first overlay marks 125 and the second overlay marks 135. That is, the photoresist pattern 140 may be a merged version of the first overlay marks 125 and the second overlay marks 135 in the same plane. First and second patterns described above may be alternately and repeatedly arranged to form grating-based patterns.

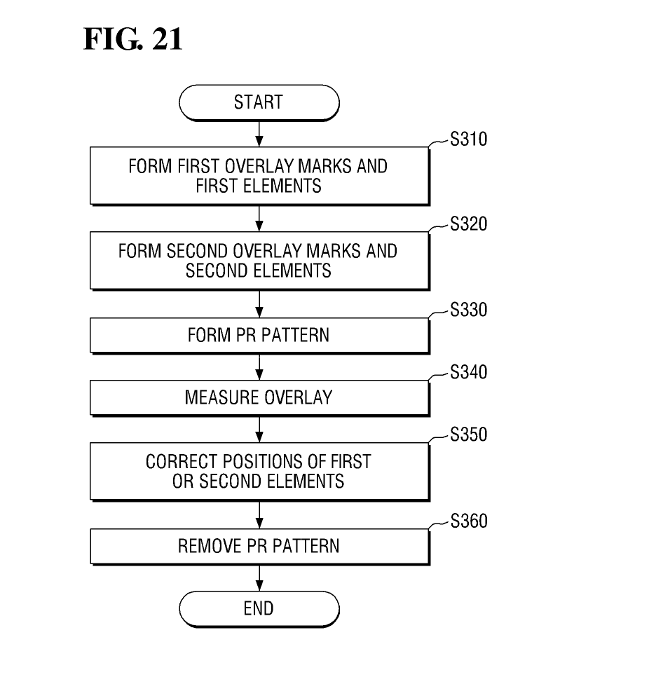

FIGS. 21 through 26 are diagrams illustrating a method of forming an overlay pattern according to another example embodiment. For simplicity, a redundant description of elements substantially identical to those of the above-described example embodiments will be omitted, and the following example embodiment will be described, focusing mainly on differences with the above-described example embodiments.

Referring to FIGS. 21 through 23, first elements are formed in a first region I, and first overlay marks 125 are formed in a second region II (operation S310). The first elements and the first overlay marks 125 may include the same material and may be formed at the same time, but the example embodiments are not limited thereto. A case where the first elements are gate electrodes 220 will be described below as an example, but the example embodiments are not limited to this example.

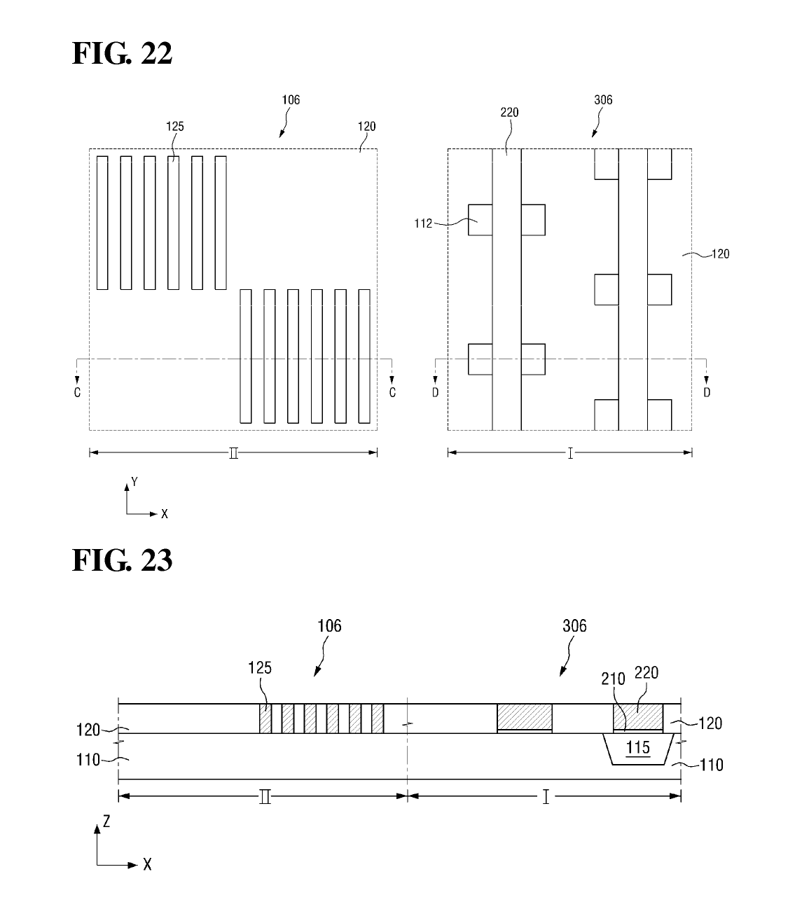

FIG. 23 is a cross-sectional view taken along the lines C-C and D-D of FIG. 22.

Referring to FIGS. 22 and 23, a substrate 110 may include the first region I and the second region II. A semiconductor chip including a transistor 306 may be formed in the first region I, and an overlay pattern 106 may be disposed in the second region II. For example, the overlay pattern 106 may be disposed in a scribe lane.

The transistor 306 of the first region I may include the substrate 110, a device isolation layer 115, an active region 112, gate insulating layers 210, the gate electrodes 220, and a first interlayer insulating film 120. The active region 112 and the device isolation layer 115 may be formed in the substrate 110, and the gate insulating layers 210 and the gate electrodes 220 may be formed on the substrate 110. The first interlayer insulating film 120 may be formed on side surfaces of each of the gate electrodes 220.

The overlay pattern 106 of the second region II may include the first interlayer insulating film 120 and the first overlay marks 125 formed on the substrate 110. The first overlay marks 125 may be formed together with the gate electrodes 220. The first overlay marks 125 may be formed to extend along a first direction (e.g., a Y-axis direction). Likewise, the gate electrodes 220 may be formed to extend along the first direction (the Y-axis direction). Since the first overlay marks 125 are formed along the first direction (the Y-axis direction), overlays of the first elements in a second direction (e.g., an X-axis direction) intersecting the first direction (the Y-axis direction) can be measured. Therefore, overlays of the gate electrodes 220 (e.g., the first elements) can be measured by measuring the first overlay marks 125. However, the example embodiments are not limited thereto.

Referring to FIGS. 21, 24 and 25, second elements of the first region I and second overlay marks 135 are formed (operation S320). The second elements and the second overlay marks 135 may include the same material and may be formed at the same time, but the example embodiments are not limited thereto. A case where the second elements are contact plugs 230 will be described below as an example, but the example embodiments are not limited to this example.

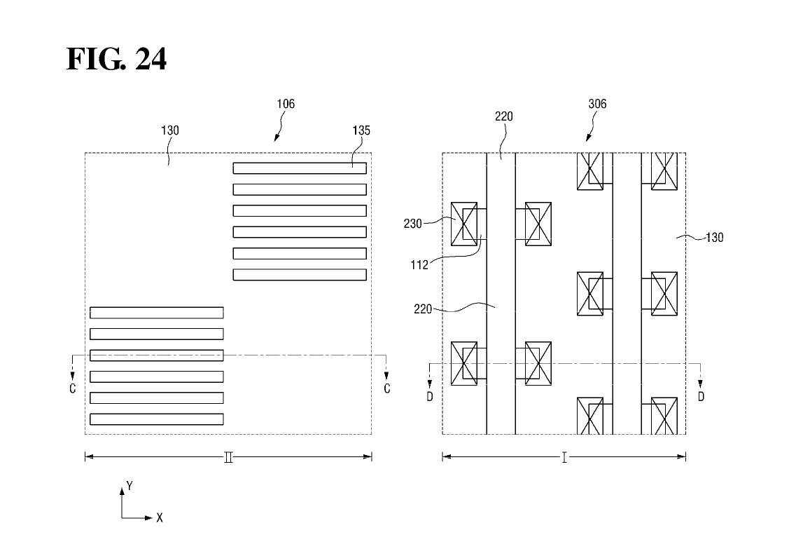

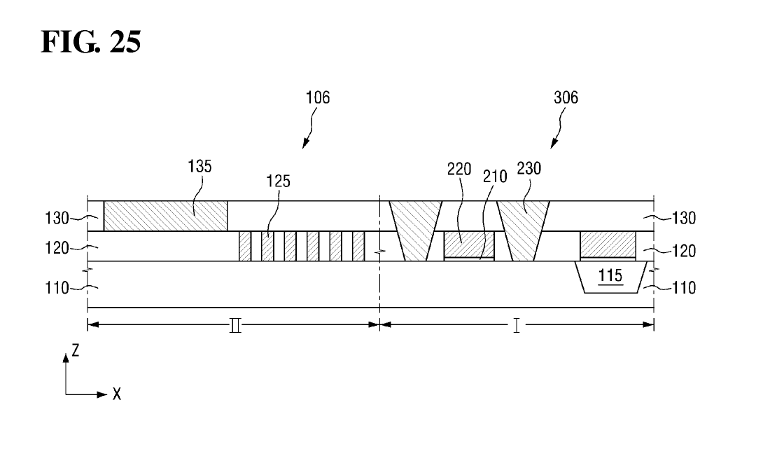

FIG. 25 is a cross-sectional view taken along the lines C-C and D-D of FIG. 24. Referring to FIGS. 24 and 25, the transistor 306 of the first region I may include a second interlayer insulating film 130 and the contact plugs 230. The second interlayer insulating film 130 may be formed on the first interlayer insulating film 120, and the contact plugs 230 may penetrate through the first interlayer insulating film 120 and the second interlayer insulating film 130 to contact the active region 112 of the substrate 110.

The overlay pattern 106 of the second region II may include the first interlayer insulating film 120 as well as the second interlayer insulating film 130 and the second overlay marks 135 located on the first overlay marks 125. The second overlay marks 135 may be formed together with the contact plugs 230. The second overlay marks 135 may be formed to extend along the second direction (e.g., the X-axis direction). Likewise, the contact plugs 230 may be formed to extend along the second direction (the X-axis direction). Since the second overlay marks 135 are formed along the second direction (the X-axis direction), overlays of the second elements in the first direction (e.g., the Y-axis direction) intersecting the second direction (the X-axis direction) can be measured. Therefore, overlays of the contact plugs 230 (e.g., the second elements) can be measured by measuring the second overlay marks 135. However, the example embodiments are not limited thereto.

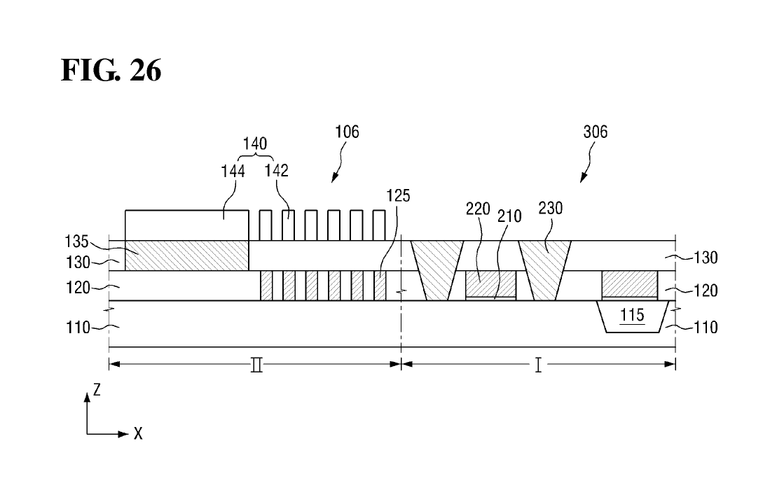

Referring to FIGS. 21 and 26, a photoresist pattern 140 is formed on the second interlayer insulating film 130 and the second overlay marks 135 (operation S330). As described above, the photoresist pattern 140 may be formed to overlap the first overlay marks 125 and the second overlay marks 135.

Referring back to FIG. 21, an overlay is measured using the photoresist pattern 140 and the first overlay marks 125 or the second overlay marks 135 (operation S340). Specifically, an overlay may be measured using a method in which the degree of overlap between a pattern formed in a previous step and a pattern formed in a current step is measured using diffracted light. That is, an overlay between the photoresist pattern 140 and the first overlay marks 125 and an overlay between the photoresist pattern 140 and the second overlay marks 135 can be measured simultaneously, but the example embodiments are not limited thereto.

The positions of the first elements or the second elements are corrected using measured data (operation S350). Specifically, the result of overlay measurement is read, and a subsequent process is performed if the result (the measured value) is “spec-in,” or within the specification requirements. If the result (the measured value) is “spec-out,” or outside of the specification requirements, a correction value for misalignment is calculated and reflected when next first elements and next second elements are formed. However, the example embodiments are not limited thereto

After the completion of the overlay process, the photoresist pattern 140 is removed (operation S360). An additional process may be performed before the removing of the photoresist pattern 140. For example, if the contact plugs 230 are formed as the second elements, a third interlayer insulating film may be formed on the second interlayer insulating film 130 and then etched to form contacts that contact the contact plugs 230, but the example embodiments are not limited thereto.

Through the above-described process, an effective overlay value of each of the first and second elements can be measured, and the measured overlay value can be reflected in a subsequent process.

The overlay measurement process can be observed from the perspective of a receiving end that receives measured data, for example, from the perspective of the processor part 40 of FIG. 1. Specifically, the processor part 40 may receive data about overlay marks used to measure an overlay of a first element formed on the substrate 10 and then measure the overlay of the first element. Here, the processor part 40 may receive data only about first overlay marks from among the first overlay marks extending along a first direction and second overlay marks extending along a second direction intersecting the first direction and then measure the overlay of the first element. In other words, a first layer of the example embodiments may include only the first overlay marks extending along the first direction and does not include the second overlay marks extending along the second direction. Therefore, data about the first overlay marks only can be received.

In addition, the processor part 40 may receive data about overlay marks used to measure an overlay of a second element formed on the substrate 10 and different from the first element and may measure the overlay of the second element. Here, the processor part 40 may receive data about fourth overlay marks only from among third overlay marks extending along the first direction and the fourth overlay marks extending along the second direction and may measure the overlay of the second element. Likewise, a second layer of the example embodiments includes only the fourth overlay marks extending along the second direction and does not include the third overlay marks extending along the first direction. Therefore, data about the fourth overlay marks only can be received.

The processor part 40 may receive data about the first overlay marks and data about the fourth overlay marks sequentially or simultaneously, but the example embodiments are not limited thereto.

As described above, the example embodiments can measure an effective overlay value of each of a first element and a second element using one overlay pattern. Accordingly, the number of overlay patterns used can be reduced, thereby reducing the area of a scribe lane in which the overlay patterns are to be placed. In addition, the overlay pattern of the example embodiments can measure overlay values of the first and second elements simultaneously. Therefore, overlay measurement time can be reduced compared with when an overlay of each element is measured separately.

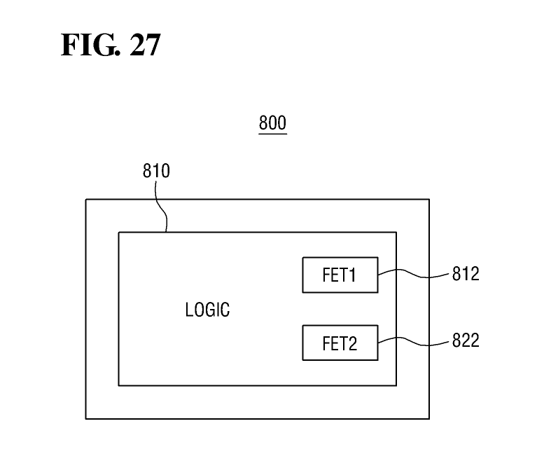

FIG. 27 is a block diagram of a semiconductor device using overlay measurement devices or methods according to example embodiments.

In FIG. 27, a logic region 810 and a static random access memory (SRAM) region 820 are illustrated as an example, but the example embodiments are not limited to this example. The example embodiments are also applicable to the logic region 810 and a region where a different memory (e.g., DRAM, MRAM, RRAM, PRAM, etc.) is formed.

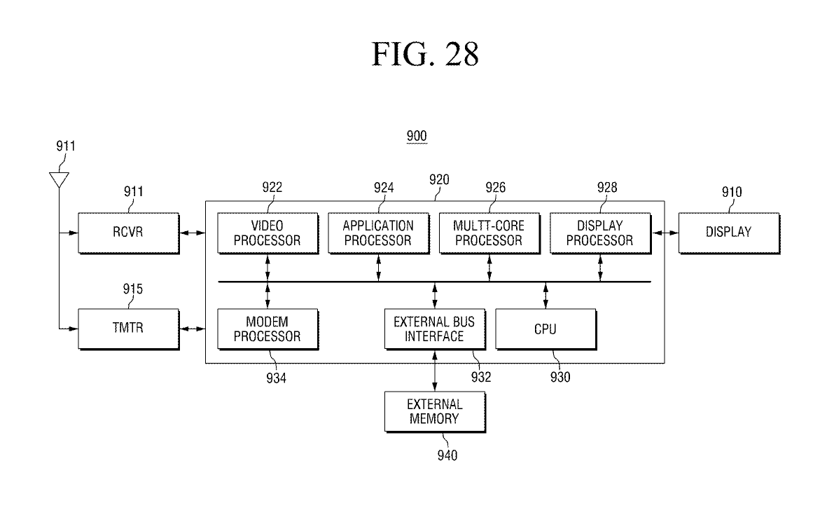

FIG. 28 is a block diagram of a wireless communication device 900 including a semiconductor device that uses overlay measurement devices or methods according to example embodiments.

Referring to FIG. 28, the wireless communication device 900 may be a cellular phone, a smartphone terminal, a handset, a personal digital assistant (PDA), a laptop computer, a video game unit, or some other device. The device 900 may use Code Division Multiple Access (CDMA), Time Division Multiple Access (TDMA), such as Global System for Mobile communications (GSM), or some other wireless communication standard.

The device 900 may provide bidirectional communication via a reception path and a transmission path. On the reception path, signals transmitted by one or more base stations may be received by an antenna 911 and provided to a receiver (RCVR) 913. The RCVR 913 conditions and digitizes the received signal and provides samples to a digital section 120 for further processing. On the transmission path, a transmitter (TMTR) 915 receives data transmitted from the digital section 920, processes and conditions the data, generates a modulated signal, and transmits the modulated signal to one or more base stations via the antenna 911.

The digital section 920 may be implemented as one or more digital signal processors (DSPs), microprocessors, reduced instruction set computers (RISCs), etc. In addition, the digital section 920 may be fabricated on one or more application specific integrated circuits (ASICs) or some other type of integrated circuits (ICs).

The digital section 920 may include various processing and interface units such as, for example, a modem processor 934, a video processor 922, an application processor 924, a display processor 928, a controller/multi-core processor 926, a central processing unit (CPU) 930, and an external bus interface (EBI) 932.

The video processor 922 may perform processing for graphics applications. Generally, the video processor 922 may include any number of processing units or modules for any set of graphics operations. Certain portions of the video processor 922 may be implemented as firmware and/or software. For example, a control unit may be implemented as firmware and/or software modules (e.g., procedures, functions, etc.) that perform functions described herein. The firmware and/or software codes may be stored in a memory and executed by a processor (e.g., the multi-core processor 926). The memory may be implemented inside or outside the processor.

The video processor 922 may implement a software interface such as Open Graphics Library (OpenGL), Direct3D, etc. The CPU 930 may execute a series of graphics processing operations, together with the video processor 922. The controller/multi-core processor 926 may include two or more cores. The controller/multi-core processor 926 may allocate a workload to be processed to two cores according to the workload and process the workload simultaneously.

In the drawing, the application processor 924 is illustrated as an element of the digital section 920. However, the example embodiments are not limited thereto. In some example embodiments, the digital section 920 may be integrated into one application processor 924 or one application chip.

The modem processor 934 may perform operations needed to deliver data between each of the RCVR 913 and the TMTR 915 and the digital section 920. The display processor 928 may perform operations needed to drive a display 910.

A semiconductor device using the overlay measurement devices or methods according to the above-described example embodiments may be used as a cache memory or a buffer memory utilized for the operations of the processors 922, 924, 926, 928, 930 and 934.

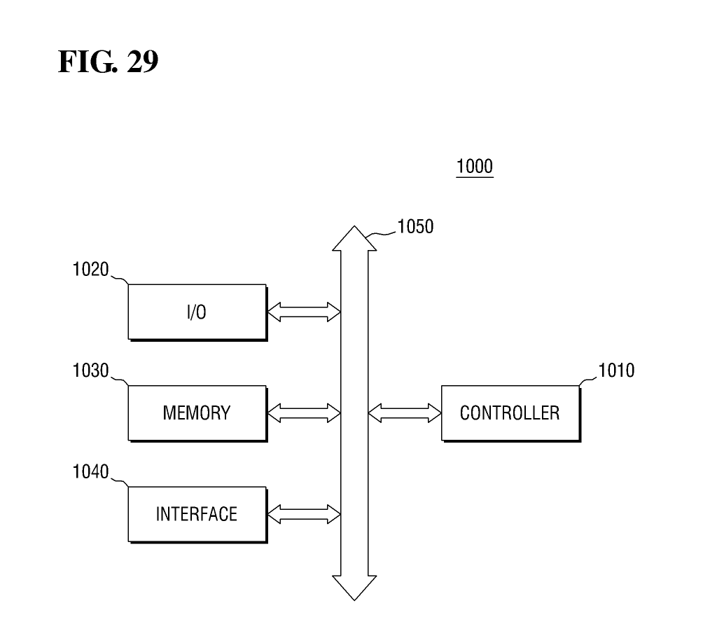

An electronic system including a semiconductor device that uses overlay measurement devices or methods according to example embodiments will now be described with reference to FIG. 29.

FIG. 29 is a block diagram of an electronic system 1000 including a semiconductor device that uses overlay measurement devices or methods according to example embodiments.

Referring to FIG. 29, the electronic system 1000 according to an example embodiment may include a controller 1010, an input/output (I/O) device 1020, a memory device 1030, an interface 1040 and a bus 1050. The controller 1010, the I/O device 1020, the memory device 1030 and/or the interface 1040 may be connected to one another by the bus 1050. The bus 1050 may serve as a path for transmitting data.

The controller 1010 may include at least one of a microprocessor, a digital signal processor, a microcontroller and logic devices capable of performing similar or same functions to those of a microprocessor, a digital signal processor and a microcontroller. The I/O device 1020 may include a keypad, a keyboard and a display device. The memory device 1030 may store data and/or commands. The interface 1040 may be used to transmit data to or receive data from a communication network. The interface 1040 may be a wired or wireless interface. In an example, the interface 1040 may include an antenna or a wired or wireless transceiver.

Although not illustrated in the drawing, the electronic system 1000 may be an operating memory for improving the operation of the controller 1010, and may also include a high-speed DRAM or SRAM. Here, any one of the overlay measurement devices or methods according to the above-described example embodiments may be employed as the operating memory. In addition, any one of semiconductor devices using the overlay measurement devices or methods according to the above-described embodiments may be provided in the memory device 1030 or in the controller 1010 or the I/O device 1020.

The electronic system 1000 may be applied to nearly all types of electronic products capable of transmitting and/or receiving information in a wireless environment, such as a PDA, a portable computer, a web tablet, a wireless phone, a mobile phone, a digital music player, a memory card, etc.

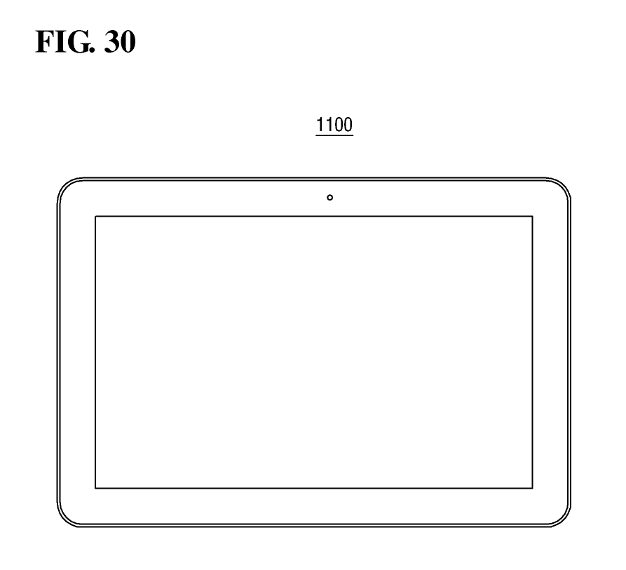

FIGS. 30 through 32 illustrate examples of a semiconductor system to which a semiconductor device using overlay measurement devices or methods according to example embodiments can be applied.

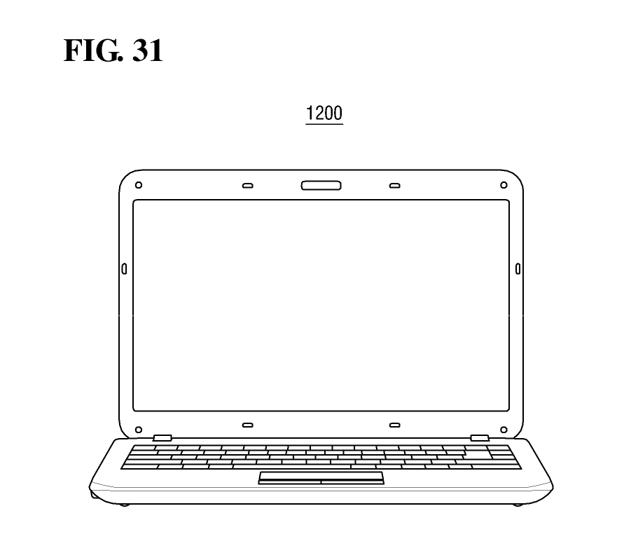

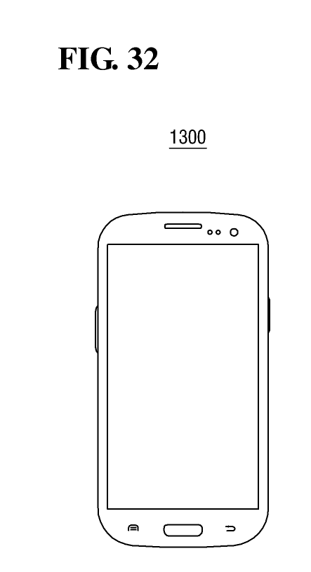

FIG. 30 illustrates a tablet personal computer (PC) 1100, FIG. 31 illustrates a notebook computer 1200, and FIG. 32 illustrates a smartphone 1300. At least one of the semiconductor devices using the overlay measurement devices or methods according to the above-described example embodiments, as set forth herein, may be used in the tablet PC 1100, the notebook computer 1200, and the smartphone 1300.

Semiconductor devices according to example embodiments, as set forth herein, may also be applied to various IC devices other than those set forth herein. That is, while the tablet PC 1100, the notebook computer 1200, and the smartphone 1300 have been described above as examples of a semiconductor system according to the example embodiment, the examples of the semiconductor system according to the example embodiment are not limited to the tablet PC 1100, the notebook computer 1200, and the smartphone 1300. In some example embodiments, the semiconductor system may be provided as a computer, an Ultra Mobile PC (UMPC), a work station, a net-book computer, a PDA, a portable computer, a wireless phone, a mobile phone, an e-book, a portable multimedia player (PMP), a portable game console, a navigation device, a black box, a digital camera, a 3-dimensional television set, a digital audio recorder, a digital audio player, a digital picture recorder, a digital picture player, a digital video recorder, a digital video player, etc.

While the example embodiments has been particularly shown and described with reference to example embodiments thereof, it will be understood by those of ordinary skill in the art that various changes in form and details may be made therein without departing from the spirit and scope of the example embodiments as defined by the following claims. It is therefore desired that the present example embodiments be considered in all respects as illustrative and not restrictive, reference being made to the appended claims rather than the foregoing description to indicate the scope of the example embodiments.

1. An overlay measurement device comprising:
a tray part including a substrate having a first region and a second region;
a measurement part configured to measure an overlay of a first or second element using a photoresist pattern and first or second overlay marks; and
a processor part configured to receive data measured by the measurement part and to correct a position of the first or second element,
wherein the substrate comprises:
a first layer including the first overlay marks to measure the overlay of the first element in the first region, the first layer extending along a first direction in the second region;
a second layer including the second overlay marks to measure the overlay of the second element in the first region, the second layer extending along a second direction, which intersects the first direction, in the second region, the second layer not including overlay marks extending along the first direction; and
the photoresist pattern being formed on the first and second layers and overlapping the first and second overlay marks.

2. The overlay measurement device of claim 1, wherein the first layer only includes the first overlay marks configured to measure an overlay in the second direction, and the second layer only includes the second overlay marks configured to measure an overlay in the first direction.

3. The overlay measurement device of claim 1, wherein at least one of the first overlay marks and the second overlay marks are grating-based marks.

4. The overlay measurement device of claim 1, wherein the photoresist pattern comprises two or more adjacent rectangular regions, each of the rectangular regions including first patterns or second patterns, wherein the first patterns are such that a photoresist extends along the first direction, and the second patterns are such that the photoresist extends along the second direction.

5. The overlay measurement device of claim 1, wherein the first direction is a direction in which the first element extends, and the second direction is substantially orthogonal to the first direction.

6. The overlay measurement device of claim 5, wherein the first element comprises a gate electrode, and the second element comprises a contact plug.

7. The overlay measurement device of claim 1, wherein at least one of the first overlay marks and the first element comprise SiON, TiN, W, or TiAIC.

8. The overlay measurement device of clam 1, wherein at least one of the second overlay marks and the second element comprise TiN, W, or TiAIC.

9. The overlay measurement device of claim 1, wherein at least one of the first and second overlay marks comprises a group of sub-patterns.

10-15. (canceled)

16. An overlay measurement device comprising:
a substrate having a first region and a second region; and
an overlay pattern on the second region, the overlay pattern including:
a first layer on the substrate and having first overlay marks extending along a first direction;
a second layer on the first layer having second overlay marks extending along a second direction substantially orthogonal to the first direction; and
a photoresist pattern on the second layer and overlapping the first and second overlay marks.

17. The overlay measurement device of claim 16, wherein the first overlay marks and the second overlay marks do not overlap in a direction perpendicular to a surface of the substrate.

18. The overlay measurement device of claim 16, wherein the first layer only includes the first overlay marks and the second layer only includes the second overlay marks.

19. The overlay measurement device of claim 16, wherein the photoresist pattern includes first patterns oriented in a same direction as the first overlay marks and second patterns oriented in a same direction as the second overlay marks.

20. The overlay measurement device of claim 19, wherein
one or more of the first patterns correspond to one or more of the first overlay marks; and
one or more of the second patterns correspond to one or more of the second overlay marks.

21. The overlay measurement device of claim 16, wherein at least one of the first overlay marks, the second overlay marks and the photoresist pattern comprise one or more sub-patterns.

22. The overlay measurement device of claim 16, wherein at least one of the first overlay marks and the second overlay marks are grating-based marks.

23. The overlay measurement device of claim 16, wherein the photoresist pattern comprises two or more adjacent regions, each region including one of first patterns and second patterns, the first patterns extending along the first direction and the second patterns extending along the second direction.

24. The overlay measurement device of claim 16, further comprising:
a tray including the substrate;
a measuring device configured to measure an overlay of at least one of a first element and a second element using at least one of the photoresist pattern, the first overlay marks and the second overlay marks, the first and second elements being in the first region.

25. The overlay measurement device of claim 24, wherein the first element comprises a gate electrode, and the second element comprises a contact plug.

26. The overlay measurement device of claim 24, wherein
at least one of the first overlay marks and the first element include SiON, TiN, W, or TiAIC; and
at least one of the second overlay marks and the second element include TiN, W, or TiAIC.
